(19) United States
(12) Patent Application Publication
(10) Pub. No.: US 2016/0267165 A1
(43) Pub. Date: Sep. 15, 2016

(54) Automated Key Words (Phrases) Discovery In Document Stacks And Its Application To Document Classification, Aggregation, and Summarization

(71) Applicant: Hui Wang, Frisco, TX (US)

(72) Inventor: Hui Wang, Frisco, TX (US)

(21) Appl. No.: 14/658,157

(22) Filed: Mar. 14, 2015

(51) Int. Cl. G06F 17/30

(52) U.S. Cl. CPC G06F 17/30598; G06F 17/30401; G06F 17/3053; G06F 17/30528

(57) ABSTRACT

This invention automatically extracts key words (phrases) from a stack of electronic documents and apply them to classify, aggregate, and summarize the contents of the documents. It not only provides compressed information for its users to quickly find out popular themes in the document, but also screens out non-critical information such sentiments and false claiming so that its users can focus on the critical information. The ability to compare positive and negative information side-by-side provides further convenience.

### SUMMARY OF INVENTION

We live in the age of information explosion. While the intention of information is for people to make informed decisions, too much information can actually distort or even discourage this purpose. This invention, though is built by targeting rampant user reviews of manufactured products, is quite promising for the purpose of first-stage classification, aggregation, and summarization of critical information over potentially millions of documents on many websites. It can then provide human users much finite choices to select from and drill down. The rest of the description of this invention will be centered around processing user reviews, for the sake of clarity and simplicity. Note this invention's application can be easily adapted to other sections such as travel, news, even politics, and many more.

In order to help users to make informed decisions, most shopping websites provides product reviews from past product buyers and users. With the same intention, travel-related websites, news websites, and even political websites all provide tools for users to leave their own opinions and reviews. However, the sheer volume of the reviews can quickly overload anyone whose intention is to discover truthful and critical information, let alone that the information was frequently buried by useless emotional lash-outs and sometimes ill-intentioned false statements.

By leveraging the latest development of natural language processing (NLP), computer software, and hardware, I have invented this tool to perform the following tasks:

1. Automatically identify hot topics in large stack of documents and present them to the users in a classified fashion, by taking advantage of some basic facts of the subject (such as the subject's name, category, and well-known characters). This leverage of the well-known, yet simple facts of the subject has proven indispensable to this invention.

2. Merging repetitive information so that the users can gain the most insight with the least amount of time.

3. Screen out useless sentimental reviews and misleading information. Though sentimental and misleading information are wide-spread, they are generally lack of coherence and consistency within the stack of documents (such as reviews). This invention takes advantage of this fact and screen them out statistically.

4. Leveraging the rating systems most websites have and present to the users both positive summaries and negative summaries. The side-by-side comparison can immediately prevent ill-intentioned reviews to dominate the landscape.

5. Providing product manufactures a concise overview of the user experience of their products. For small manufactures, it may take a few months for a single site like Amazon.com to provide them enough user feedbacks. However, the automated, computerized nature of this invention can be easily implemented to gather feedbacks from many websites without much effort. Thus it can shorten the product feedback cycles and enable the manufactures to provide better product and services quickly.

This invention has taken full advantage of NLP's development in tokenization, part-of-speech tagging, lemmatization (stemming), chunking (phrase), dependency parsing, semantic role labeling, coreference resolution, named-entity resolution, synonyms identification, document classification, text summarization, and topic modeling. With little effort, this technique can be easily expanded to key phrases.

### BRIEF DESCRIPTION OF DRAWING

Please note that the presentation of above results can be customized into any reasonable user interface arrangement. Below a tabbed web user interface is used to show the results and merits of this invention.

Example 1: Nintendo Wii Console Black with Wii Sports and Wii Sports Resort (http://www.amazon.com/Nintendo-Wii-Console-Black-Sports- Resort/dp/B009M72E5Q/ref=sr 1 1?ie=UTF8&qid=1423870406&sr=8- 1&keywords=Nintendo+Wii+Console+Black+with+Wii+Sports+and+Wii+Sports+Resort)

This product has 272 user reviews on www.amazon.com. Its user rating is 4.5/5.0 as of Feb. 12, 2015.

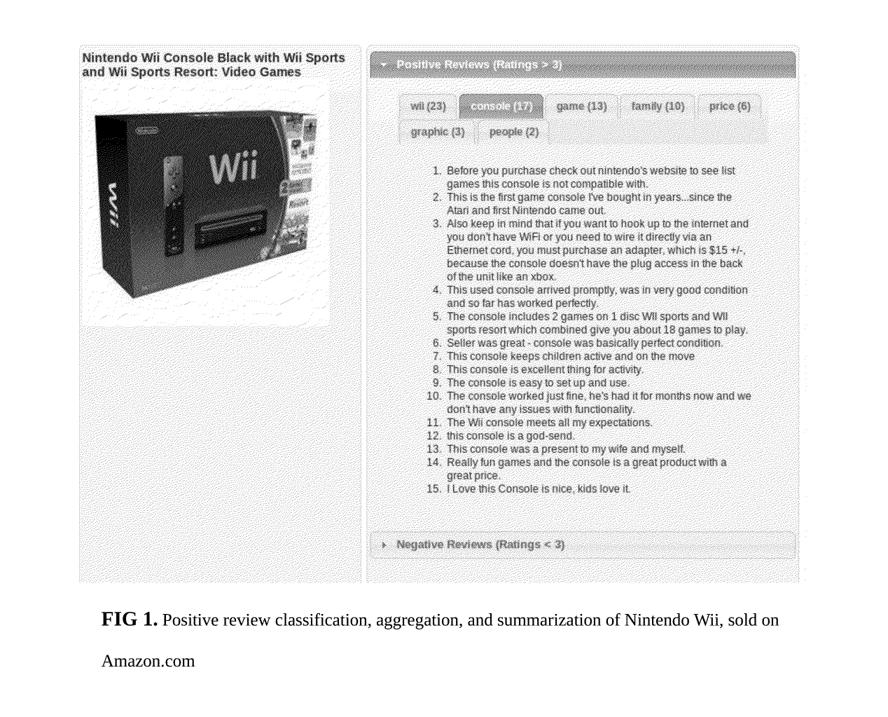

In FIG. 1, the “console” keyword tab is selected. It is shown that this keyword (and its synonyms) was in 17 user sentences (indicated on the tab). It is ranked as the second most important keyword among the positive reviews (which include reviews with 5 or 4 stars). Here is the text for this tab and the lines are arranged based on a proprietary importance measurement to make sure the most important review appear on top:

1. Before you purchase check out nintendo's website to see list games this console is not compatible with

2. This is the first game console I've bought in years . . . since the Atari and first Nintendo came out.

3. Also keep in mind that if you want to hook up to the internet and you don't have WiFi or you need to wire it directly via an Ethernet cord, you must purchase an adapter, which is $15+/−, because the console doesn't have the plug access in the back of the unit like an xbox.

4. This used console arrived promptly, was in very good condition and so far has worked perfectly.

5. The console includes 2 games on 1 disc WII sports and WII sports resort which combined give you about 18 games to play.

6. Seller was great—console was basically perfect condition.

7. This console keeps children active and on the move

8. This console is excellent thing for activity.

9. The console is easy to set up and use.

10. The console worked just fine, he's had it for months now and we don't have any issues with functionality.

11. The Wii console meets all my expectations.

12. this console is a god-send.

13. This console was a present to my wife and myself.

14. Really fun games and the console is a great product with a great price.

15. I Love this Console is nice, kids love it.

As we can see. The first sentence, as a candid advice, would be the greatest help to other potential shoppers. The last sentence is only an expression of sentiment, which contains the least technical information regarding this product. Moreover, only 15 sentences are listed, instead of 17 (indicated on the tab), because two sentences had overlap information content with the top 15 sentences. Therefore, they were discarded. We will take a look at the negative review aggregation below.

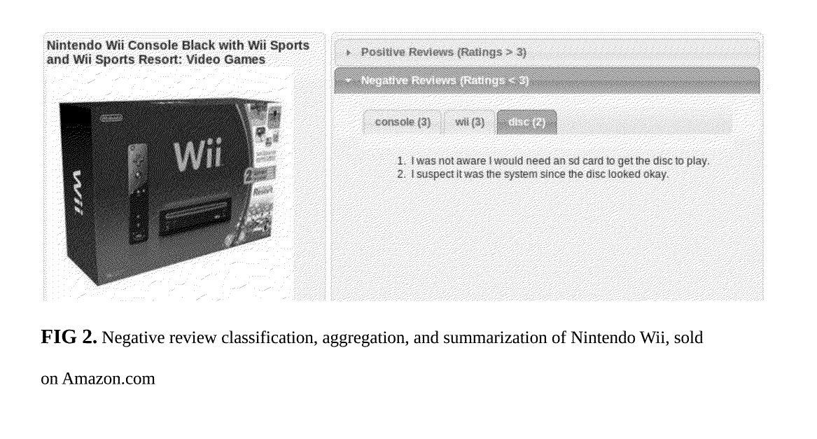

In FIG. 2, the “positive reviews” tab has been collapsed while the “negative reviews” is expanded. Negative review keywords were extracted from reviews rated 1 or 2 stars. Keyword “disc” is selected. Compared with FIG. 1, the negative reviews keywords appeared much fewer times, which makes sense because the overall rating 4.5/5.0 means users are highly satisfied with this product. Here is the text:

1. I was not aware I would need an sd card to get the disc to play.

2. I suspect it was the system since the disc looked okay.

Even with only 2 sentences mentioning a disc issue, the potential shopper can choose to be alerted or to ignore it (since it only appeared twice). Nonetheless, the user is fully armed with this potentially problematic information while making the purchase decision.

The time to check both positive reviews and negative reviews took me about 1 to 2 minutes, instead of grudgingly spending hours reading through all 272 reviews and trying to aggregate useful technical information. Personally I never had the patience to read more than 15 reviews, nor anyone lives around me. This detailed summary of the reviews is proven to be priceless here.

Example 2: USB 2.0 256 gb Flash Drive: Computers & Accessories (http://www.amazon.com/USB-2-0-256 gb-Flash-Drive/dp/B00FHL3F0E/ref=sr 1 18? ie=UTF8&qid=1423803195&sr=8-18&keywords=usb+drive)

This product has 109 reviews on www.amazon.com. Its user rating is 2.5/5.0 as of Feb. 12, 2015

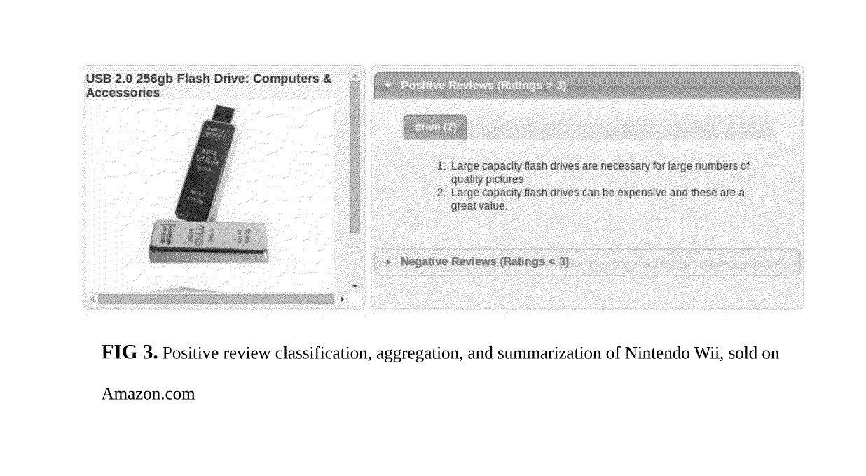

In FIG. 3, the summarized positive reviews are displayed. Only keyword “drive” was significant enough to show up. It only appeared in two sentences. Here is the text:

1. Large capacity flash drives are necessary for large numbers of quality pictures.

2. Large capacity flash drives can be expensive and these are a great value.

The above two sentences can be seen to be hardly very positive. They are at most neutral opinions. The fact of lacking positive reviews is hardly surprising because it's over user rating is pretty low.

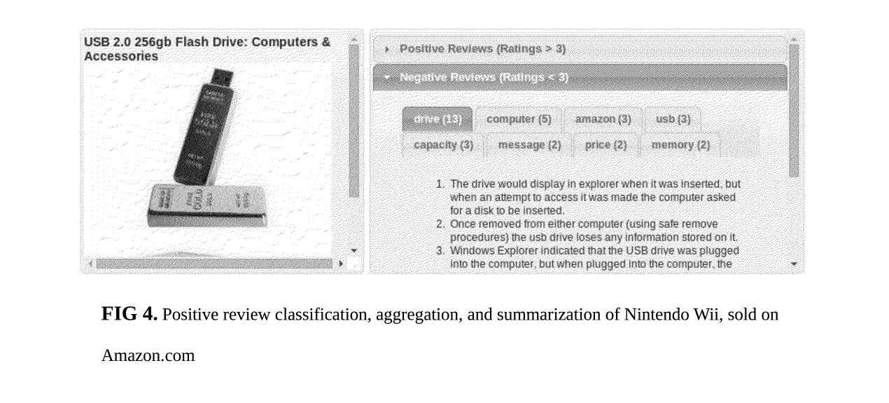

In FIG. 4, the negative review summaries are displayed. Since this product only received an overall rating of 2.5/5.0, negative reviews far outweighs the positive reviews, simply based on the numbers of keywords and their associated sentences. The same keyword “drive” appeared in 13 sentences in negative reviews. Here is the full text:

1. The drive would display in explorer when it was inserted, but when an attempt to access it was made the computer asked for a disk to be inserted.

2. Once removed from either computer (using safe remove procedures) the usb drive loses any information stored on it.

3. Windows Explorer indicated that the USB drive was plugged into the computer, but when plugged into the computer, the Autoplay screen did not appear.

4. The drive rarely connects and when it does it keeps disconnecting.

5. I ordered and paid for this 256 GB flash drive to use as a removable back-up for approximately 125 GB of data.

6. This flash drive worked for about 10 minutes when initially plugged it in.

7. By the second time, the USB drive had stopped working.

Unsatisfied users has detailed their frustration with this product in just a few sentences. The symptoms of the problems are vivid through only the above 7 sentences. Amazingly, sentimental sentences, which are common in negative reviews, were completely screened out. Also please note that “drive” appeared in 13 sentences. Here only 7 sentences were displayed because the other 6 sentences had overlapping information. This further saves potential shopper's time of investigation.

Through the above two examples and four figures, it is easy to see the advantages described in the summary section.

### INDUSTRIAL APPLICABILITY

This invention's commercial value has been summarized in the “Summary” section.

1. Automated extraction of keywords (phrases) based on some easily attainable facts of the subject (such as subject name, category etc.).

2. Classify, aggregate, and summarize information in the documents through key words or phrases. By further leveraging the easily attainable facts of the subject, the information can be compressed efficiently.

3. Leverage existing ratings system to summarize for pros and cons and display them in close proximity for easy comparison.

4. No need to modify the sentences in the documents. The original content is displayed without modification.

5. Linking specific summary sentences to the original documents so that users of this invention can choose to obtain more information.

6. Screen out sentimental information and focus on relevent topic information based on the fact that these information are lack of coherence.
